(19) United States
(12) Patent Application Publication
(10) Pub. No.: US 2012/0012672 A1
(43) Pub. Date: Jan. 19, 2012

(54) DRYWALL SPRAYING ASSEMBLY

(76) Inventors: Richard Hibbard, Portland, OR (US); Richard Gherardini, Portland, OR (US)

(21) Appl. No.: 13/023,417

(22) Filed: Feb. 8, 2011

Related U.S. Application Data
(63) Continuation of application No. 11/747,861, filed on May 11, 2007, now abandoned.
(60) Provisional application No. 60/799,463, filed on May 11, 2006.

(51) Int. Cl. B05B 9/00; B05B 9/03

(52) U.S. Cl. 239/142; 239/146

(57) ABSTRACT

A spraying assembly is provided for delivering a coating material to a surface. The assembly of an embodiment comprises a mobile support structure, a mixing tank coupled to the support structure and a mixing device connected to the mixing tank. A mixture dispensing assembly has a conduit coupled to the mixing tank and a dispenser through which a flowable mixture is dispensed. The assembly has an hydraulic system having at least one closed hydraulic loop, a hydraulically-driven air compressor coupled to the hydraulic system, and a hydraulic pump assembly coupled to the closed loop of the hydraulic system. The hydraulic pump assembly is configured to pump the mixture at a selected flow rate from the mixing tank to the mixture dispensing assembly, and a remotely-actuated flow control assembly configured to control the flow rate of the mixture to the mixture dispensing assembly. The flow control assembly having a control unit adjustable by a user remote from the hydraulic pump to change the flow rate of the mixture to the dispenser.

### CROSS REFERENCE TO RELATED APPLICATION

This patent application is a non-provisional patent application claiming priority to U.S. Patent Application No. 60/799,463 and entitled Drywall Spraying Assembly, filed May 11, 2006, and it which is hereby incorporated in its entirety by reference thereto.

### TECHNICAL FIELD

The present invention is directed to equipment and methods for applying coating material to drywall or other surfaces.

### BACKGROUND

Drywall spraying equipment is typically designed to stir and mix drywall mud or other spray-on coatings that can be pumped through a hose and dispensed through a spray-gun or other spraying mechanism. The hoses are fairly long, so a user can work remotely from the tank. The pump is connected to the tank and the hose to move the mud through the hose to the dispensing gun. Prior art systems have experienced drawbacks; for example, the tanks with hoppers are typically relatively tall. Bags of drywall mud mix are typically 60-80 pound bags, which can be difficult to lift and pour into the hopper, particularly if the hopper is tall. Other systems have mixing paddles within the tank that often splash the mix as the mixer blades rotate within the tank. Other systems include hinged doors welded to the tanks to cover the top of the tank and these hinged doors are susceptible to damage. Other systems include motors and pumps that stick out from the tank's sidewall, thereby increasing the overall width of the unit.

Other prior art systems have experienced drawbacks because the controls for the motors and pump system are provided on the trailer adjacent to the tank. If a worker is operating the spray-gun and dispensing the mud at a location remote from the tank and the worker needs to adjust the flow of the mud, the operator must stop spraying and walk back to the trailer so as to adjust the pump controls. This adjustment process is very inefficient and increases the time required to complete a job. Accordingly, there is a need for an improved drywall spraying system.

### BRIEF DESCRIPTION OF THE DRAWINGS

FIG. 1 is a schematic isometric view of a drywall spraying assembly in accordance with an embodiment of the invention.

FIG. 2 is a schematic cross-sectional view of a hopper, tank and frame of the assembly of FIG. 1.

FIG. 3 is a side elevation view of a tank assembly of the drywall spraying assembly of FIG. 1, wherein the tank assembly is shown removed from the mobile support structure.

FIG. 4 is an enlarged side elevation view of a locking door-hinge of the tank assembly of FIG. 3.

FIG. 5 is an enlarged side elevation view of a lift handle on the door of the tank assembly of FIG. 3, wherein the door is shown in a closed position covering a grate on a hopper portion of the tank assembly.

FIG. 6 is an exploded isometric view of the tank assembly of FIG. 3.

FIG. 7 is an enlarged side elevation view of a tank support plate and a pump housing of the tank assembly of FIG. 3.

FIG. 8 is a top plan view of the tank support plate of FIG. 5 shown removed from the tank, the support plate having a plurality of mounting apertures forming a universal motor of mounting system.

FIG. 9 is a schematic illustration of a hydraulic system of an embodiment of the assembly of FIG. 1.

FIG. 10 is a schematic view of the drywall spraying assembly of FIG. 1 and the hose and gun system with a remote controller in accordance with an embodiment of the invention.

Appendix A—Photos of portions of an embodiment of a drywall spraying assembly.

### DETAILED DESCRIPTION

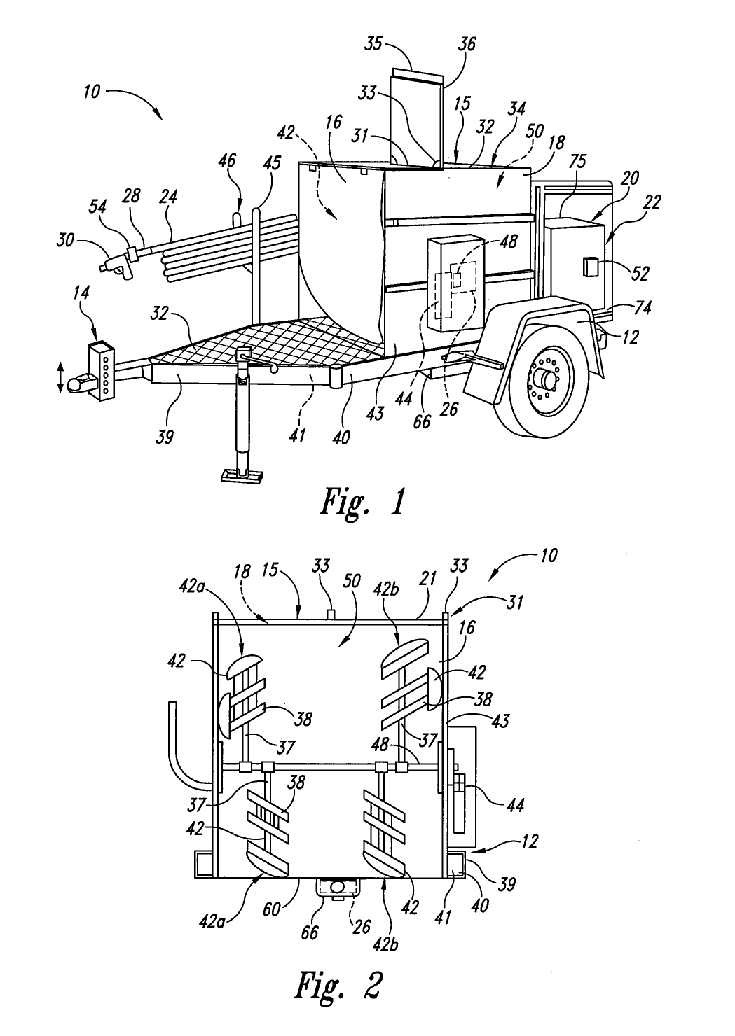

Embodiments of the present invention include an operator friendly drywall spraying assembly. Several specific details of the invention are set forth in the following description and in FIGS. 1-10 to provide a thorough understanding of embodiments of the invention. One skilled in the art, however, will understand that the present invention will have additional embodiments, and that other embodiments of the invention may be practiced without one or more of the specific features described below. In other instances, well known structures, materials, or operations are not shown or described in order to avoid obscuring aspects of the invention.

FIG. 1 is a schematic isometric view of a drywall spraying assembly 10 in accordance with an embodiment of the invention. The assembly includes a mobile support structure, such trailer 12 with an adjustable tow hitch 14. The trailer 12 supports a tank assembly 15 that includes a tank 16 and a hopper 18. The trailer 12 also supports a hydraulic system 20, and an electrical system 22 coupled to the tank 16 and the hopper 18. An elongated hose 24 is coupled to the tank 16 and to a pump 26 that drives mud from the tank to a distal end 28 of the hose 24. A mud-disposing device, such as a handheld or pole gun 30, is attached to the distal end 28 of the hose 24.

The hopper 18 is configured to receive dry mud mix. The hopper 18 has a grate 32 over the top 34 to prevent unwanted items from entering the hopper 18. in the illustrated embodiment, a tank assembly 15 has a door 36 positioned to cover the grate 32 and close out the hopper 18 when the door is in a closed position. The hopper 18 is connected to the tank 16 so the dry mix can be metered into the tank and mixed with water.

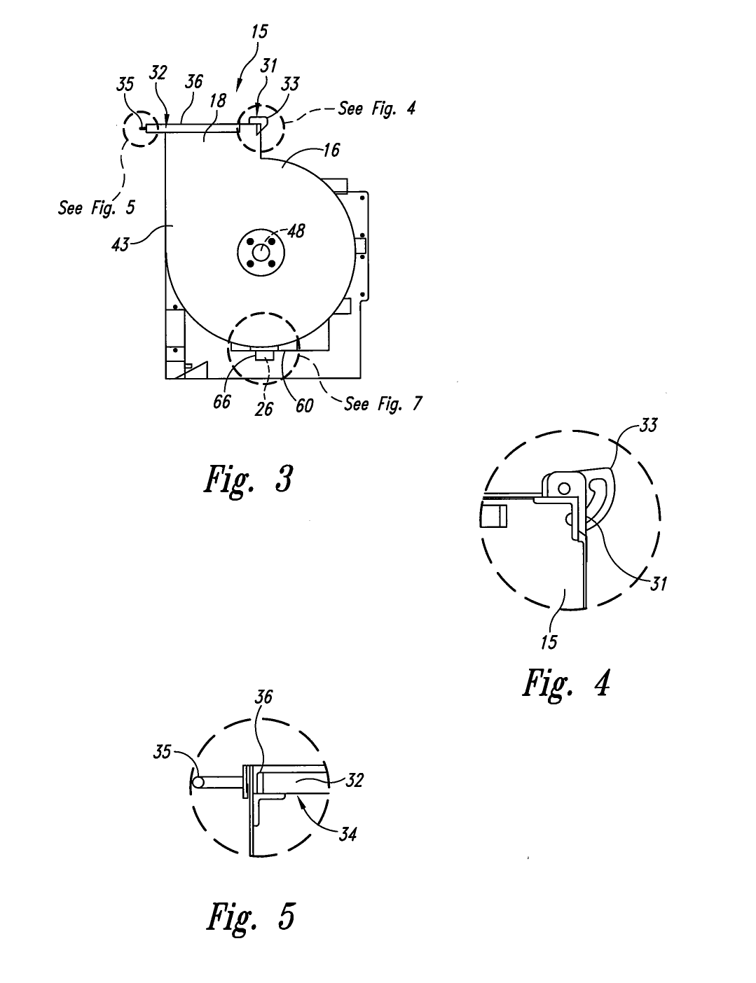

As best seen in FIGS. 3 and 4, the door 36 of the illustrated embodiment is pivotally connected to the tank assembly 15 and is moveable between open and closed positions. The door 36 is connected to a locking hinge 31 with releasable lock portions 33 configured to releasably lock and door 36 in the open position. Accordingly, the door 36 will remain in the open position until a user actively moves the door to overcome the locking feature so that door can be closed. This locking hinge 31 provides an operator-friendly configuration that helps prevent the door 36 from inadvertently or prematurely move to the closed position. The door 36 also includes a lift handle 35 opposite the locking hinge 31. The lift handle 35 is configured to allow a user to grasp and lift the door 36 toward the open position. The door 36 can also be balanced so the door can move easily and smoothly between the open and closed positions.

The tank 16 of the illustrated embodiment is a stainless steel 200- or 300-gallon tank, although other size tanks can be used. For example, one embodiment of the assembly 10 can be provided with a 150-, 200-, 300-, 350-, 450- or 500-gallon tank. In one embodiment, the 150-, 200-, 300-, and 350-gallon tanks 16 all have the same size footprint, so any one of these tanks can be interchangeably mounted onto the same trailer 12. This interchangeability of tanks having the same footprints during manufacturing or retrofit allows a single style of a trailer or other mobile support structure to be used, thereby reducing the cost of the assembly 10 and increasing manufacturing efficiency. Accordingly, fewer parts are needed for the systems in various configurations, so that the manufacturing costs of the unit are reduced. In one embodiment, the tank 16, such as the larger 450- or 500-gallon tank, can be mounted on a skid configured to be installed on a vehicle. In another embodiment, the drywall spraying assembly 10 can include other mobile support structures onto which the tank 16 and the other components of the assembly are assembled, so as to provide a mobile unit that can be easily transported as a self-contained unit to different work sites.

As best seen in FIG. 2, the tank assembly 15 includes the plurality of mixing paddles 42 rotatably disposed within the tank 16 and coupled to a mixing motor 44 mounted to the sidewall 43 of the tank 16. In the illustrated embodiment, the tank 16 is a stainless steel J-tank. The mixing paddles 42 are mounted on a shaft 48 that extends across the interior 50 of the tank 16 and is coupled to the mixing motor 44. The mixing paddles 42 are oriented at a selected angle relative to the shaft 48 and are configured actively to stir, fold, or otherwise mix a mud mixture (which is formed by dry mixture components combined with water). In one embodiment, the mixing paddles 42 have a connection rod 37 securely fastened generally perpendicular to the shaft 48 and blade portions 38 attached to the connection rod. The blade portions 38 are oriented at an angle in the range of 46-degrees to 50-degrees, inclusive, relative to the shaft 48. In another embodiment, the blade portions 38 are oriented at approximately a 47-degree angle relative to the shaft 48. The angular orientation and the shape of the mixing paddles 42 are such that the paddles minimize splashing of the mud during the mixing process, such that mud does not splash out of the open top 34 of the tank 16 in the event that the hinged door 36 is open.

In the illustrated embodiment, the tank assembly 15 includes four mixing paddles 42, although a greater or less number of paddles can be used in other embodiments. The four paddles 42 are arranged with two left paddles 42a on a left side of the tank's interior area, and two right paddles 42b on a right side of the interior area 50. The two left paddles 42a are laterally offset from each other (i.e., not axially aligned) and radially offset from each other (i.e., they extend from the shaft radially away from each other). Similarly, the two right paddles 42b are laterally and radially offset from each other. The blade portions 38 on the two left paddles 42a are oriented so that when the blade portions move through the mud, the blade portions push and direct the mud in generally opposite directions during the mixing process. For example, one of the blade portions 38 on one of the left paddles 42a push the mud toward the right side of the interior area, and the paddle portions 38 on the other of the left paddles 42a push the mud the other direction toward the left side of the interior area 50. The two right paddles 42b are similarly oriented to direct the mud in generally opposite directions during the mixing process. As a result, the mixing paddles 42 are able to mix the mud to a ready condition for spraying in a substantially shorter time period than achieved in conventional systems.

The tank assembly 15 is configured so the tank 16 and hopper 18 arrangement have a low profile and are attached to the bottom portion of the trailers frame. The low profile tank 16 and hopper 18 have an uppermost edge that is substantially lower relative to the trailer 12 than experienced in a prior art. As a result, it is much easier for a user to lift heavy bags of mix and empty them into the hopper 18. The grate 32 over the hopper 18 helps protect from the user putting their hands or arms into the hopper 18 during the mixing process. It also prevents a bag of mix or other items from inadvertently falling into the hopper 18.

The top 34 of the tank 16 is closed by the hinged door 36. in one embodiment, the hinge 31 is configured to be a repairable and/or replaceable hinge such that in the event the door 36 or the hinge is damaged. The hinge 31 and/or the door 36 can be removed and replaced with a new hinge and door configuration. The door 36 is also a self-latching unit that provides for easy closure of the top 34 of the tank 16.

In the illustrated embodiment of FIG. 1, the tow hitch 14 on the trailer 12 is an adjustable six-point hitch configured to allow the connection member that attaches to a ball of a vehicle to be positionable at different heights relative to the frame of the trailer 12. Accordingly, the tow hitch 14 allows the unit to be fitted to a wide range of makes and models of cars and trucks that have tow-ball configurations while allowing the trailer 12 to remain substantially level. The frame 39 of the trailer 12 has a hollow and sealed tubular portion 40 that defines a pressurized air chamber 41. During construction, the tubular portion 40 of the frame 39 is built and sealed to provide a sealed chamber. Then, a sealing and anti-corrosion coating, such as paint, is sprayed into the tubular portion 40. In one embodiment, an elongated applicator tube with a spray nozzle at the end is inserted all the way into the tubular portion 40 and the paint or other coating material is sprayed through that tube out of the nozzle in a substantially 360-degree spray pattern, thereby coating the inner surface of the frame's tubular portion 40. As the material continues to spray out of the nozzle, the applicator tube is slowly drawn back out of the frame tubular portion 40. As a result, the entire inside of the air chamber 41 is fully coated and sealed and protected. In one embodiment, the air chamber 41 in the trailer 12 frame is lined with a specially formulated paint for rust protection. The extra air storage provided inside the frame's air chamber 41 acts to hold consistent cool air pressure.

The trailer 12 also includes a front grate 32 bolted in front of the tank 16 and provides a continuous surface up to the edge of the tank 16 and allows a user to stand on the grate 32 during operation. The grate 32 can be bolted onto the frame 39 and can be removed as needed for service on the lower portion of the stater tubes or other portions of the drywall spraying assembly 10 under the frame and 39. This arrangement provides a user-friendly configuration data allows for easy and fast access to the various components of the assembly for general maintenance, repair, or replacement.

The assembly of the illustrated embodiment has a hose rack 45 with three hooks 46 that provide for support of the elongated hose 24 when coiled up and in a stored position. The hose 24 can be a long hose, such as 100-200 feet, although other lengths of hoses could be used. The assembly 10 can be configured for providing two hoses that can be operated simultaneously. The assembly 10, however, has a single hydraulic system 20 that operates to provide the mud to one or both of the hoses on demand.

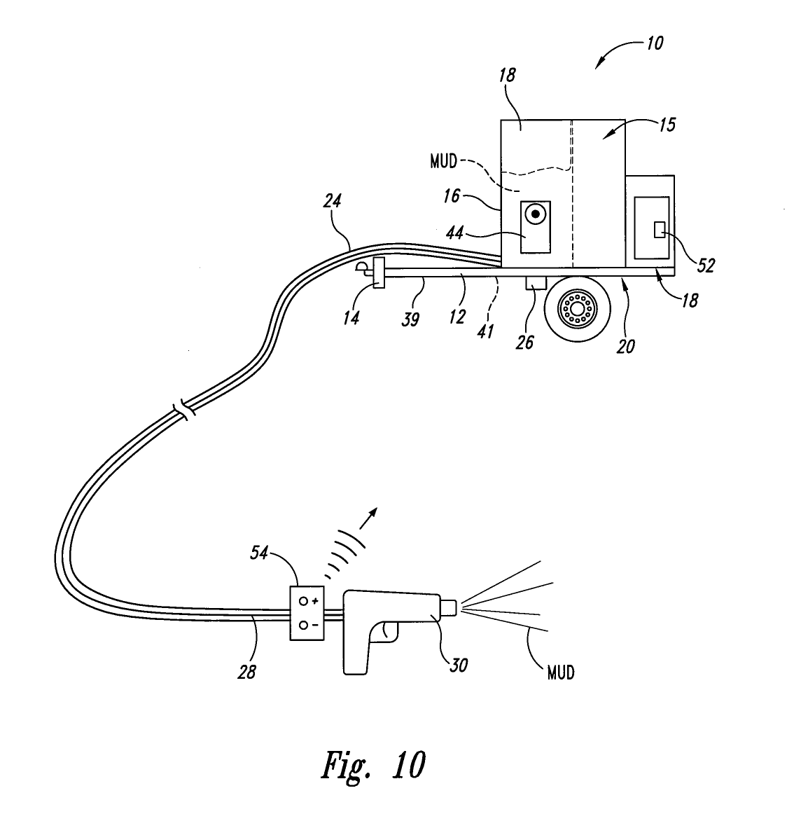

The hydraulic system 20 includes a hydraulic pump 26 coupled to the hose 24 and to the tank 16. The hydraulic pump 26 of the illustrated embodiment is a progressive cavity pump configured to received a flow of the mud from and outlet 69 in the bottom of the tank 16 and to pump the mixed mud through the hose 24 to the gun 30 on the distal end 28 of the hose. As best seen in FIG. 10, the hydraulic pump 26 is coupled to a controller 52 that can be controlled by a user remote from the trailer 12. In the illustrated embodiment, the controller 52 is a remotely controlled, wireless linear actuator controller configured to adjust the speed of the hydraulic fluid driving the pump 26 upon receiving signals from a remote signaling device, referred to as a control unit 54. Other embodiments can use other remotely controlled controllers.

The remote control unit 54 of the illustrated embodiment is a “wireless”control unit that communicates wirelessly with the controller 52 to control and/or adjust the speed of the hydraulic pump 26, thereby adjusting the flow rate of the mud through the hose 24 and the gun 30. In another embodiment, the control unit 54 can be hard wired to the controller 52 such as by a control line that extends along the hose 24. In another embodiment, the control line can be an integral part of the hose. This remote control unit 54 allows the user to adjust the flow of mud without having to walk all the way back to the trailer 12 and adjust the pump 26 manually, thereby reducing the time it takes to complete a spraying job. In one embodiment, the remote control unit 54 is attached to the gun 30. In another embodiment, the remote control unit 54 is attached to the distal end 28 of the hose 24 adjacent to the gun 30. In another embodiment, the remote control unit 54 can be removably connected to the hose 24 such that a person can remove the remote control unit from the hose 24 and/or the gun 30. In another embodiment, the remote control unit 54 is a handheld device carried by the user while still being able to remotely control the hydraulic pump 26 and the speed of the mud delivery to the gun 30.

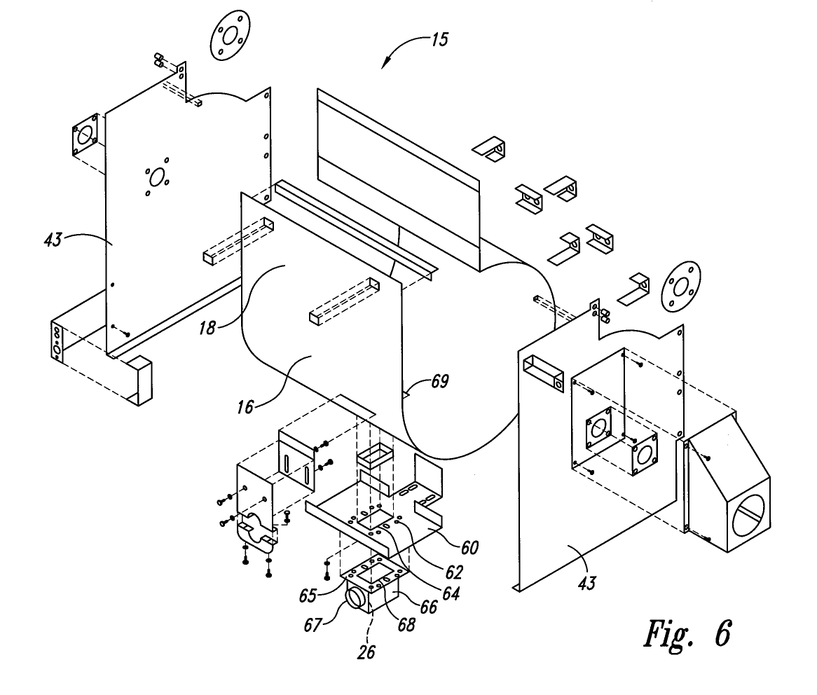

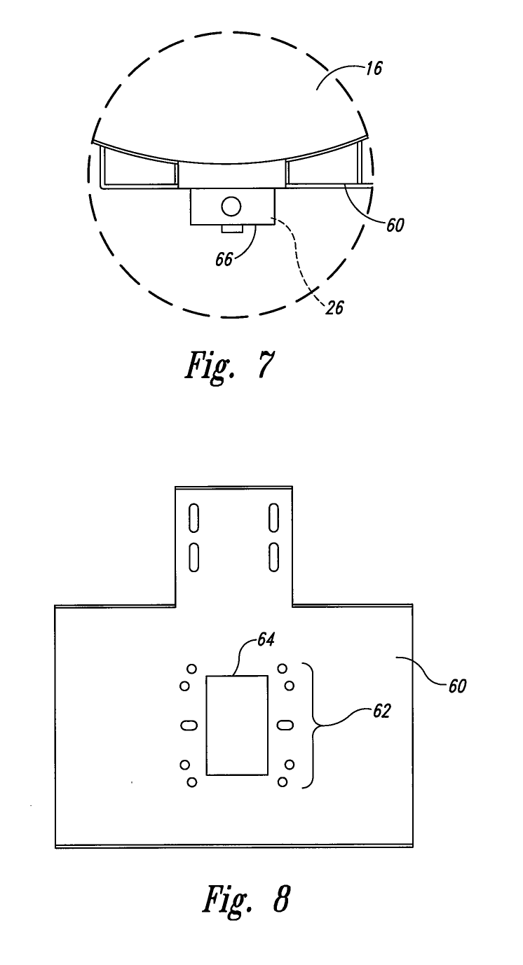

As best seen in FIGS. 6 and 7, the tank assembly 15 includes a support plate 60 connected to the bottom of the tank 16 the support plate is configured to mount onto the trailer and 12 (FIG. 1) or other mobile support device to securely fixed the tank in place. The support plate 60 of the illustrated embodiment is welded or otherwise securely fixed to the bottom of the tank 16. The hydraulic pump 26 is mounted to the bottom of the support plate 60. The support plate 60 is configured to provide additional rigidity to the tank 16 and to absorb and shield the tank from a torque generated by the hydraulic pump 26 during operation. Accordingly, the tank 16 is not exposed to these torsional forces and stresses, thereby resulting in a longer operational life of the tank.

FIG. 8 is an enlarged top plan view of the support plate 60 removed from the tank. The support plate 60 of the illustrated embodiment includes a plurality of mounting holes 62 disposed about an enlarged central opening 64 through the support plate. The mounting holes 62 are arranged to form a universal mounting pattern that will allow anyone of a plurality of pumps can be mounted onto the support plate to pump the mud from the tank 16 through the hose 24 (FIG. 1). The mounting holes 62 are spaced around the central opening 64 which is configured to allow the mud from the tank to pass their through into the hydraulic motor for pumping through the hose. Although the illustrated embodiment shows a series of five mounting holes 62 on each side of the central opening 64, other embodiments can use other mounting hole configurations and arrangements to accommodate the selected mounting configurations for other pumps.

Referring again to FIG. 6, the tank assembly 15 has a pump housing 66 sealably connected to the bottom of the support plate 60 in alignment with the central opening 64. The pump housing 66 of the illustrated embodiment includes a seal or gasket 65 that engages the bottom of the support plate to form a seal therebetween. Accordingly, mud from the tank 16 exits the outlet 69 and enters the pump housing 66 through an inlet 68 to the pump 26 in the housing. In the illustrated embodiment, the pump housing 66 has apertures 67 at the ends through which portions of the pump extend (such as a drive shaft and stator tube). The pump housing 66 of the illustrated embodiment also includes a drain plug that provides access into the pump housing to drain mud therefrom. The pump housing 66 is easily excessive bull from under the trailer 12, such that the pump housing can be easily and quickly removed to access the pump 26, such as for routine cleaning and/or maintenance.

In the illustrated embodiment of FIG. 1, an engine mounting plate and 74 is provided with a one-half inch plate having universal mounting templates configured to quickly and easily receive engines made by multiple different manufacturers. Accordingly, different engines can be easily and quickly mounted to the mounting plate 74 depending upon an engine selected by a potential customer.

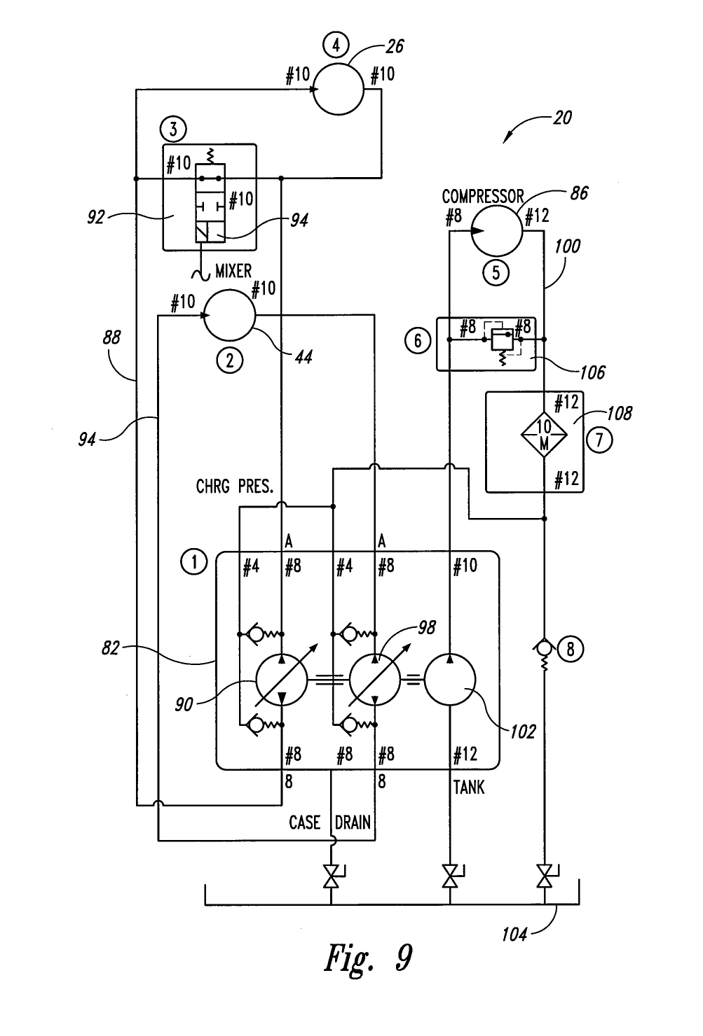

FIG. 9 is a schematic illustration of the hydraulic system 20 of an embodiment of the assembly of FIG. 1. The hydraulic system 20 of the illustrated embodiment is a single-stage, high pressure hydraulic system with approximately 2,000 PSI. The hydraulic system 20 includes a hydrostatic pump assembly 82, which is driven by a power plant, such as a diesel or gas-powered motor 75 (FIG. 1). The hydrostatic pump assembly 82 is configured to drive the hydraulic pump 26 attached to the bottom of the tank assembly 15 (FIG. 1), as discussed above to provide the selected flow rate of the mud delivered to the gun. The hydrostatic pump assembly 82 also drives the mixer motor 44 to mix the mud within the tank, and also with the hydraulically powered air compressor 86 that provides the pressurized air provided to the gun for spraying of the mud.

In the hydraulic system of 80 in the illustrated embodiment includes a first closed loop 88 connected to a hydrostatic pump device 90 and to the pump 26, discussed above. The hydrostatic pump device 90 is adjustable to provide hydraulic fluid at a selected flow rate to the pump 26, thereby controlling pump's operating speed and the associated mud flow rate. The first closed loop 88 also includes an on-off valve switch 92. The switch 92 can be activated to direct hydraulic fluid to the pump 26 when the valve switch is in the “on” position. The switch and 92 is also configured to allow a hydraulic fluid to bypass the pump 26 when the switch is in the “off” position.

In one embodiment, an electric bypass device 94 connected to the switch 90. The bypass device 94 has a pressure sensor connected to the hydraulic fluid line and is configured to automatically move the switch 92 to the “off” position when the pressure sensor detects the pressure within the first closed loop exceeds a maximum allowable level. When the switch 92 is moved to the “off” position, the hydraulic fluid is allowed to substantially really circulate back to the hydrostatic pump 82 through the closed loop system. This bypassing of the hydraulic fluid prevents over pressurization of the first closed loop 88, which could result in damage to the hydraulic lines or components therein. This bypassing of the hydraulic fluid also allows the hydraulic fluid to remain within a cool operating temperature, particularly during extended use of the assembly 10.

The hydraulic system 20 has a second closed loop 94 connected to a second hydrostatic pump assembly 98. The second closed loop 94 is connected to the mixer motor 44 that drives the mixing paddles 42 (FIG. 2), as discussed above. The second hydrostatic pump device 98 can be adjustable to control the speed of the mixing paddles.

When the first or second hydrostatic pump devices 90 or 98 is turned off, the hydraulic fluid does not flow through the respective loop 88 or 94, thereby allowing the hydraulic fluid to dissipate accumulated heat. Accordingly, additional cooling systems are not needed to coolly the hydraulic fluid in the closed loops.

The hydraulic system 20 has a third loop 100 connected to another hydrostatic pump assembly 102. This third loop 100 is an open loop that draws hydraulic fluid from a reservoir 104, directs the hydraulic fluid through a pressure relief valve 106 to the air compressor 86. The air compressor 86 is configured to provide pressurized air to the air chamber 41 (FIG. 1) for use in spraying the mud from the gun 30 (FIG. 1), as discussed above. The third loop 100 also has a filter assembly 108 down stream of the air compressor to filter the hydraulic fluid before it returns to the reservoir 104.

In the illustrated embodiment, the hydraulically-driven air compressor is coupled directly to the motor 75 (FIG. 1) via a modified flexible lovejoy connection, such that the compressor does require belts, which have a tendency to loosen or wear out over time. In addition, the hydraulically-driven air compressor 86 is configured to operate at a constant speed (i.e., rpm) and to provide consistent air pressure. Accordingly, the hydraulic system 20 is such that an operator can not over-speed the system, thereby protecting against excessive or accelerated wear of the equipment.

The machine is balanced for use with one or more hoses simultaneously. In one embodiment, a slider valve is provided at the pump 26 housing between the tank 16 and the pump 26. The slider valve can be activated to stop 34 the flow of drywall mud or other material to be sprayed to allow for easy servicing of the pump 26. An easy, clean, and deluxe texture filter can be provided that is coupled to the pump 26.

Additional features of the system include Teflon bushings provided between the tanks and the drive shaft 48 coupled to the paddles 42. No additional bearing assemblies are needed for double action or dual-independent mixing tank 16s or independent mixing paddles 42.

From the foregoing, it will be appreciated that specific embodiments of the invention have been described herein for purposes of illustration, but that various modifications may be made without deviating from the spirit and scope of the invention. Accordingly, the invention is not limited, except by the appended claims.

We claim:

1. A spraying assembly for delivering a coating material to a surface, comprising:
a mobile support structure;
a mixing tank coupled to the support structure and configured to mix a coating material into a flowable mixture;
a mixing device connected to the mixing tank;
a support plate connected to the mixing tank and having a mounting portion with a plurality of mounting apertures configured to form a plurality of mounting patterns;
a mixture dispensing assembly configured to receive and dispense the mixture, the mixture dispensing assembly including a conduit coupled to the mixing tank and a dispenser through which the mixture is dispensed;
an electrical system connected an electrical power source;
a hydraulic system having at least one closed hydraulic loop;
a hydraulically-driven air compressor coupled to the hydraulic system;
a hydraulic pump assembly coupled to the closed loop of the hydraulic system and attached to the mounting portion at a selected one of the plurality of mounting patterns, the hydraulic pump assembly configured to pump the mixture at a selected flow rate from the mixing tank to the mixture dispensing assembly; and
a remotely-actuated flow control assembly configured to control the flow rate of the mixture to the mixture dispensing assembly, the flow control assembly having a controller coupled to the hydraulic pump and being adjustable to change the flow rate of material from the hydraulic pump, and the flow control assembly having a control unit positionable proximate to the dispenser when the dispenser is dispensing the coating material to the surface, the control unit being adjustable by a user remote from the hydraulic pump to change the flow rate of the mixture to the dispenser.

2. The assembly of claim 1 wherein the dispenser is a spray gun, and the control unit is proximate to the spray gun.

3. The assembly of claim 1 wherein the mixing tank includes a tank body with an open top, and further comprising a closure member connected to the tank body and being moveable between open and closed positions, the closure member configured to be releasably restrained in the open position.

4. The assembly of claim 1 wherein the controller is operatively connected to an adjustable actuator coupled to the hydraulic system and configured to adjust a hydraulic fluid flow rate to the hydraulic pump.

5. The assembly of claim 1, further comprising a mixing assembly connected to the tank, and a hydraulic drive motor connected to the mixing assembly and operatively coupled to the hydraulic system.

6. The assembly of claim 5 wherein the hydraulic system has a second closed loop, and the hydraulic drive motor is connected to the second closed loop.

7. The assembly of claim 1, further comprising a mixing assembly with a plurality of mixing paddles connected to a drive shaft, the mixing paddles having a paddle portions oriented at an angle in the range of approximately 47-degrees-50-degrees, inclusive, relative to a plane normal to the drive shaft.

8. The assembly of claim 7 wherein the mixing assembly includes a hydraulic drive motor connected to the drive shaft and to the hydraulic system.

9. The assembly of claim 8 wherein the hydraulic drive motor is a 90-degree drive motor.

10. The assembly of claim 1, further an electrical bypass device coupled to the first loop and configured to re-direct hydraulic fluid to bypass the hydraulic drive motor upon detection of a selected condition.

11. The assembly of claim 1 wherein the mobile support structure is a trailer.

12. The assembly of claim 1 wherein the support plate includes a support portion that defines a tank foot print configured to receive any one of a plurality of tanks having different volume capacities.

13. A spraying assembly for delivering a coating material to a surface, comprising:
a mobile support structure;
a mixing assembly having tank coupled to the mobile support structure and and a mixing device in the tank;
a mixture dispensing assembly configured to receive and dispense the mixture, the mixture dispensing assembly including a conduit coupled to the mixing tank and a dispenser through which the mixture is dispensed;
an air compressor coupled to the mixture dispensing assembly;
a pump assembly coupled mixing assembly and configured to pump the mixture at a selected flow rate from the mixing tank through the mixture dispensing assembly; and
a remotely-actuated flow control assembly configured to control the flow rate of the mixture to the mixture dispensing assembly, the flow control assembly having a controller coupled to the pump assembly and being adjustable to change the flow rate of material from the pump assembly, and the flow control assembly having a control unit positionable proximate to the dispenser when the dispenser is dispensing the coating material to the surface, the control unit being adjustable by a user remote from the pump assembly to change the flow rate of the mixture to the dispenser.

14. The assembly of claim 13, further comprising a support plate connected to the tank and having a pump mounting portion with a plurality of mounting apertures configured to form a plurality of mounting patterns.

15. The assembly of claim 13, further comprising a hydraulic system with a first closed loop, the pump assembly is a hydraulic pump assembly connected to the first closed loop.

16. A portable spraying assembly for dispensing a construction mud, comprising:
a mobile support structure;
a mixing tank assembly coupled to the support structure for mixing the mud;
a conduit coupled to the mixing tank assembly to carry a flow of the mud from the mixing tank assembly as a selected flow rate;
a dispensing device connected to the conduit and configured to dispense the mud;
a power plant coupled to the support structure;
a hydraulic system having first and second closed hydraulic loops and a hydrostatic pump coupled to the power plant;
an air compressor coupled to the hydraulic system and to the spray device;
a hydraulic pump assembly connected to the first closed hydraulic loop and positioned to pump the mud at a selected flow rate from the mixing tank to the spray device; and
a hydraulic mixer motor connected to the mixing tank assembly and operatively connected to the second closed hydraulic loop independent of the first hydraulic loop.

17. The assembly of claim 16, further comprising a remotely-actuated flow controller coupled to the hydraulic pump, and a remote control unit operatively coupled to the flow controller being adjustable by a user remote from the hydraulic pump to change the flow rate of the mud being delivered to the spray device.

18. The assembly of claim 16, further comprising a support plate interconnecting the mixing tank and to the mobile support structure.

19. The assembly of claim 16 wherein the dispensing device is a spray gun, and the control unit is proximate to the spray gun.

20. The assembly of claim 16 wherein the mixing tank assembly has a plurality of mixing paddles connected to a drive shaft, the mixing paddles having paddle portions oriented at an angle in the range of approximately 47-degrees-50-degrees, inclusive, relative to a plane normal to the drive shaft.

21. The assembly of claim 16 wherein the mixing tank assembly has a first and second sets of mixing paddles in the tank to mix the construction mud, each of the first and second sets of mixing paddles have first and second paddles, the first paddle configured to move the construction mud in the tank a first direction toward the second paddle relative to the tank and the second paddle configured to move the construction mud in a second direction toward the first paddle.

22. The assembly of claim 16, wherein mixing tank assembly having a drive shaft and plurality of the mixing paddles having paddle portions oriented at an angle in the range of approximately 47-degrees-50-degrees, inclusive, relative to a plane normal to the drive shaft.

23. The assembly of claim 16 wherein the hydraulic pump assembly is connected to an electrical bypass device configured to re-direct hydraulic fluid away from the hydraulic pump assembly in response to an over-pressure condition.
